(19) United States
(12) Patent Application Publication
(10) Pub. No.: US 2015/0176778 A1
(43) Pub. Date: Jun. 25, 2015

(54) LIGHTING DEVICE

(71) Applicant: OSRAM GmbH, Muenchen (DE)

(72) Inventors: Stephan Schwaiger, Ulm (DE); Oliver Hering, Niederstotzingen (DE); Thomas Reiners, Berlin (DE)

(21) Appl. No.: 14/557,470

(22) Filed: Dec. 2, 2014

(30) Foreign Application Priority Data
Dec. 19, 2013 (DE) 102013226624.3

(51) Int. Cl. F21K 99/00; F21V 23/00; F21S 8/10

(52) U.S. Cl. CPC F21K 9/58; F21K 9/56; F21S 48/1757; F21S 48/12; F21V 23/003

(57) ABSTRACT

A lighting device may include: a laser light source arrangement; at least two pivotable mirrors; and at least one light wavelength conversion element. The lighting device is embodied in such a way that light generated by the laser light source arrangement is directed onto at least one light wavelength conversion element by the pivotable mirrors. The at least two pivotable mirrors are embodied in such a way that light reflected at a first pivotable mirror is directable onto a first surface section of at least one light wavelength conversion element in order to form a first illuminatable region of the at least one light wavelength conversion element, and light reflected at a second pivotable mirror is directable onto a second surface section of the at least one light wavelength conversion element in order to form a second illuminatable region of the at least one light wavelength conversion element. The first and second illuminatable regions partly overlap.

### CROSS-REFERENCE TO RELATED APPLICATION

This application claims priority to German Patent Application Serial No. 10 2013 226 624.3, which was filed Dec. 19, 2013, and is incorporated herein by reference in its entirety.

### TECHNICAL FIELD

Various embodiments relate generally to a lighting device.

### BACKGROUND

A lighting device is disclosed in DE 10 2010 028 949 A1, for example. Said document describes a lighting device including a laser light source for generating blue light and a plurality of pivotable mirrors and also a plurality of light wavelength conversion elements. The blue light generated by the laser light source arrangement is directed onto the surface of the light wavelength conversion elements with the aid of the pivotable mirrors in order to generate white light which is a mixture of yellow light converted by the light wavelength conversion elements and non-converted blue light.

### SUMMARY

A lighting device may include: a laser light source arrangement; at least two pivotable mirrors; and at least one light wavelength conversion element. The lighting device is embodied in such a way that light generated by the laser light source arrangement is directed onto at least one light wavelength conversion element by the pivotable mirrors. The at least two pivotable mirrors are embodied in such a way that light reflected at a first pivotable mirror is directable onto a first surface section of at least one light wavelength conversion element in order to form a first illuminatable region of the at least one light wavelength conversion element, and light reflected at a second pivotable mirror is directable onto a second surface section of the at least one light wavelength conversion element in order to form a second illuminatable region of the at least one light wavelength conversion element. The first and second illuminatable regions partly overlap.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic illustration of the lighting device in accordance with the first embodiment;

FIG. 2 shows a plan view of the surface sections—illuminated by means of laser light—of the light wavelength conversion element of the lighting devices depicted in FIG. 1 and respectively FIG. 3; and

FIG. 3 shows a schematic illustration of the lighting device in accordance with the second embodiment.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments provide a lighting device of the generic type which makes it possible to reduce the loading of the light wavelength conversion element by the laser light.

The lighting device according to various embodiments may include a laser light source arrangement and at least two pivotable mirrors and at least one light wavelength conversion element, and the lighting device is embodied in such a way that light generated by the laser light source arrangement is directed onto at least one light wavelength conversion element by the pivotable mirrors, wherein according to various embodiments the at least two pivotable mirrors are embodied in such a way that light reflected at a first pivotable mirror is directable onto a first surface section of at least one light wavelength conversion element in order to form a first illuminatable region of the light wavelength conversion element, and light reflected at a second pivotable mirror is directable onto a second surface section of the light wavelength conversion element in order to form a second illuminatable region of the light wavelength conversion element, which second illuminatable region partly overlaps the first illuminatable region.

The fact that with the aid of at least two pivotable mirrors illuminated regions of the surface of the at least one light wavelength conversion element are produced, which regions partly overlap, ensures a reduction of the loading of the at least one light wavelength conversion element by the laser light because only the region of overlap of first and second illuminatable regions is illuminated with the highest intensity of the laser light. Outside the region of overlap of the first and second illuminatable regions, the first and second surface sections of the at least one light wavelength conversion element are illuminated with a lower laser light intensity, since only the laser light reflected at the first and respectively second pivotable mirror is directed onto these regions. Accordingly, the at least one light wavelength conversion element of the lighting device according to various embodiments is subjected to a lower thermal loading than the light wavelength conversion element of a lighting device in accordance with the prior art.

Moreover the lighting device according to various embodiments may have the effect that for regions which are illuminated with lower brightness, such as, for example, when the lighting device according to various embodiments is used as a light source in a motor vehicle headlight for illuminating the near field directly in front of the motor vehicle, a reduced laser light power can be made available for exciting the at least one light wavelength conversion element, and that for regions which are illuminated with the highest brightness, such as, for example, the illumination in the region of the bright-dark boundary when the lighting device according to various embodiments is used as a light source in a motor vehicle headlight, the highest laser light power can be made available for exciting the at least one light wavelength conversion element.

In various embodiments, the at least two pivotable mirrors are embodied as micromirrors, e.g. as Micro Electro Mechanical Systems mirrors (MEMS mirrors) and are e.g. embodied as pivotable about at least two mutually orthogonal pivoting axes. As a result, the first and second surface sections of the at least one light wavelength conversion element can be scanned with the laser light reflected at the pivotable mirrors. In various embodiments, the laser light reflected at the pivotable mirrors can be guided for example line by line and column by column over the first and respectively second surface section of the at least one light wavelength conversion element in order to excite the at least one light wavelength conversion element in the region of these surface sections for the emission of secondary light. The intersection point of the mutually orthogonal pivoting axes of the mirrors is e.g. situated centrally, in the area centroid on the reflection surface of the respective pivotable mirror, and the light generated by the laser light source arrangement is e.g. directed onto the reflection surface of the mirrors in the region of the intersection point of the mutually orthogonal pivoting axes. Alternatively, however, each mirror which is pivotable about two pivoting axes can also be replaced by two mirrors which are coordinated with one another and which are each pivotable only about one pivoting axis, wherein the pivoting axes of the mirrors which are pivotable only about one axis are arranged orthogonally to one another.

In various embodiments, the laser light source arrangement of the lighting device according to various embodiments includes a plurality of laser diodes.

As a result, the brightness of the light generated by the laser light source arrangement of the lighting device according to various embodiments can be varied in a simple manner, for example by individual laser diodes being switched on and off or by pulse-width-modulated driving (PWM). Moreover, as a result, the laser diodes of the laser light source arrangement can be divided in groups and assigned to different pivotable mirrors of the lighting device according to various embodiments in order to illuminate the latter. The intensity of the laser light directed onto the first and respectively second surface section of the at least one light wavelength conversion element by the pivotable mirrors can likewise be influenced in this way.

In various embodiments, provision is made of a controller for the at least two pivotable mirrors or/and the laser light source arrangement. The controller enables brightness control of the laser light source arrangement, for example by individual laser diodes of the laser light source arrangement being switched on or off or dimmed by means of the controller. Moreover, the controller enables control of the pivoting movement of the individual pivotable mirrors of the lighting device according to various embodiments. In addition, a synchronization of the pivoting movement of the respective mirror and of the brightness control of the laser light source arrangement illuminating said mirror can also be carried out by the controller.

In various embodiments, an optical apparatus for shaping the laser light beam emitted by the at least one laser light source arrangement is disposed downstream of said at least one laser light source arrangement of the lighting device according to various embodiments. Said optical apparatus enables a collimation of the laser light emitted by the at least one laser light source arrangement and a focusing of the laser light onto the at least one light wavelength conversion element via the pivotable mirrors. The laser light is e.g. focused onto the at least one light wavelength conversion element in order to obtain the smallest possible luminous spot or laser spot. Alternatively, however, it is also possible to focus the laser light in a fictitious plane situated in front of or behind the surface of the at least one light wavelength conversion element, in order to increase the size of the luminous spot on the surface of the at least one light wavelength conversion element. In various embodiments, the optical apparatus allows the light emitted by different laser diodes to be combined to form a common light beam that is directed onto a pivotable mirror by said optical apparatus and onto at least one light wavelength conversion element by the pivotable mirror. In addition, the optical apparatus makes it possible to shape the laser light beam and to define the diameter of the laser light spot or luminous spot of the laser light beam impinging on the respective pivotable mirror or on the surface of the at least one light wavelength conversion element.

In accordance with one embodiment of the lighting device, the surface sections of the at least one light wavelength conversion element which are illuminated by the pivotable mirrors are embodied in a curved fashion, e.g. in a concavely curved fashion. As a result, the diameter of the laser spot which the laser light directed by the pivotable mirrors to the at least one light wavelength conversion element causes on the surface thereof remains largely independent of the angle of incidence of the laser light on the respective pivotable mirror. In various embodiments, the laser spot diameter in the case of relatively large angles of incidence is not increased as greatly as in the case of light wavelength conversion elements having a planar surface.

The at least one light wavelength conversion element acts as a light source for a further, downstream optical unit, which is also designated as secondary optical unit. The latter images the at least one light wavelength conversion element or the light emitted by the at least one light wavelength conversion element into the far field of the motor vehicle headlight, such that the light distribution on the at least one light wavelength conversion element is transferred or imaged onto the roadway.

The at least one laser light source arrangement of the lighting device according to various embodiments may be embodied in such a way that it generates laser light having wavelengths from the wavelength range of 380 nanometers to 490 nanometers and the at least one light wavelength conversion element may be embodied in such a way that it converts light having wavelengths from the wavelength range of 380 nanometers to 490 nanometers proportionally into light having an intensity maximum in the wavelength range of 520 nanometers to 590 nanometers. As a result, by the at least one laser light source arrangement and by means of the at least one light wavelength conversion element, white light is generated which is a mixture of non-converted blue laser light and yellow light converted at the light wavelength conversion element and which can be used in a motor vehicle headlight or other projection apparatuses.

The lighting device according to various embodiments may include sensors or a camera. By the sensors or the camera, aligned for example with the roadway or in the direction of travel of the motor vehicle, a calibration of the lighting device according to various embodiments can be performed, for example. In various embodiments, by way of example, the brightness of the laser light source arrangement can be calibrated in order for example to set the illuminance on the surface of the at least one light wavelength conversion element or to adapt the illuminance or the light distribution of a motor vehicle headlight in which the lighting device according to various embodiments is used as a light source to the legal regulations. Furthermore, it is possible, by sensors, to detect events such as an oncoming vehicle, for example, and to adapt the illumination by corresponding brightness control of the laser light sources or corresponding control of the pivotable mirrors of the lighting device according to various embodiments to the present event (ADB Automated Driving Beam).

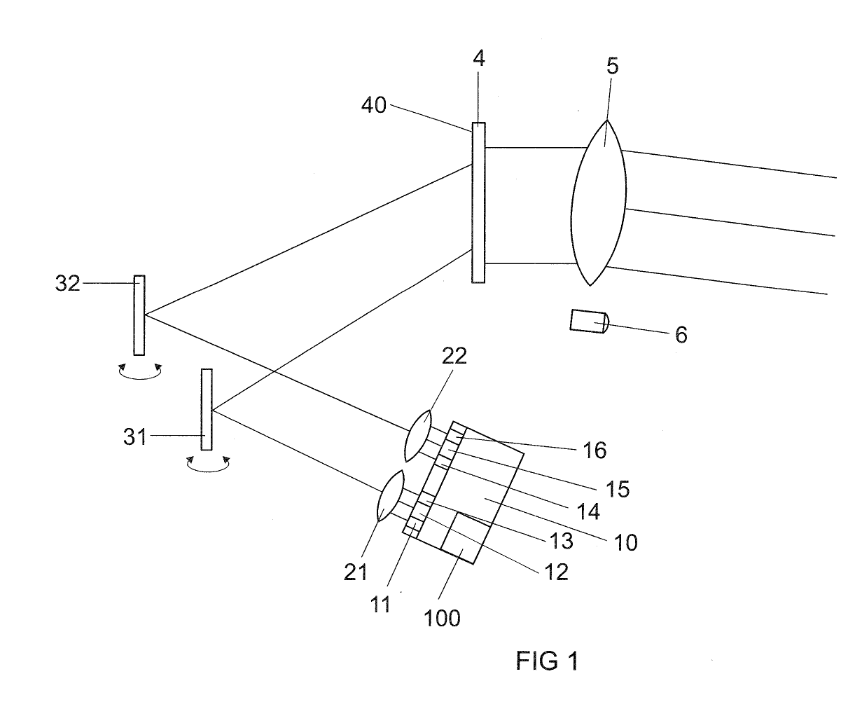

FIG. 1 schematically depicts the lighting device in accordance with the first embodiment.

This lighting device has a laser light source arrangement 10, two beam shaping optical units 21, 22, two pivotable mirrors 31, 32 and a light wavelength conversion element 4 and also a secondary optical unit 5. The latter projects the light distribution of the laser light on the light wavelength conversion element 4 for example into the far field in front of a motor vehicle, since the lighting device in accordance with the first embodiment is provided as light source and projection unit for a motor vehicle headlight.

The laser light source arrangement 10 may include or essentially consist of a plurality of laser diodes 11, 12, 13, 14, 15, 16 which each emit laser light having a wavelength from the wavelength range of 380 nanometers to 490 nanometers during their operation. The laser diodes 11, 12, 13, 14, 15, 16 are preferably embodied such that they are of identical type, and so they each generate ultraviolet radiation or blue light having a wavelength from the aforementioned wavelength range. The laser light emitted by the laser diodes 11, 12, 13 is combined to form a first laser light beam by the first beam shaping optical unit 21 and is focused onto the first pivotable mirror 31, such that it impinges substantially centrally on the reflection surface of the first mirror 31. The laser light emitted by the other laser diodes 14, 15, 16 is combined to form a second laser light beam by the second beam shaping optical unit 22 and is focused onto the second pivotable mirror 32, such that it impinges substantially centrally on the reflection surface of the second mirror 32. The laser diodes 11, 12, 13 therefore form a first group of laser diodes, which serves for illuminating the first pivotable mirror 31, while the other laser diodes 14, 15, 16 form a second group of laser diodes, which is provided for illuminating the second pivotable mirror 32.

The two pivotable mirrors 31, 32 are each embodied as Micro Electro Mechanical Systems micromirrors, also called MEMS micromirrors, and are each pivotable about two pivoting axes, wherein a first pivoting axis is oriented perpendicularly to the plane of the drawing in the case of the illustration in FIG. 1 and the second pivoting axis lies in the plane of the drawing. The two pivoting axes (not depicted) are arranged substantially in the reflection surface of the respective mirror 31 and 32 and intersect at the midpoint of the rectangular reflection surface of the respective mirror 31 and 32. The laser light beam reflected at the first pivotable mirror 31 is directed onto a first surface section 41 of the light wavelength conversion element 4. With the aid of the laser diodes 11, 12, 13 of the first laser diode group and the first beam shaping optical unit 21 and also the first pivotable mirror 31, the first surface section 41 of the light wavelength conversion element 4 is scanned with laser light line by line and column by column During the scanning process, the first mirror 31 is pivoted about its pivoting axes in order to scan the first surface section 41 with laser light, and the laser diodes 11, 12, 13 are switched on or off in this case in order to modulate the brightness of the laser light impinging on the first surface section 41. The control of the brightness of the laser diodes 11, 12, 13 of the first laser diode group and of the pivoting movements of the first pivotable mirror 31 is effected synchronously by means of a controller 100, such that every point of the first surface section 41 is illuminatable with laser light of predefinable intensity. The size or the diameter of the laser light spot which is used for scanning the first surface section 41 depends on the optical properties of the first beam shaping optical unit 21 and of the first pivotable mirror 31.

Analogously thereto, with the aid of the laser diodes 14, 15, 16 of the second laser diode group and the second beam shaping optical unit 22 and also the second pivotable mirror 32, the second surface section 42 of the light wavelength conversion element 4 is scanned with laser light line by line and column by column. During the scanning process, the second mirror 32 is pivoted about its pivoting axes in order to scan the second surface section 42 with laser light, and the laser diodes 14, 15, 16 are switched on or off in this case in order to modulate the brightness of the laser light impinging on the second surface section 42. The control of the brightness of the laser diodes 14, 15, 16 of the second laser diode group and of the pivoting movements of the second pivotable mirror 32 is effected synchronously by means of the controller 100, such that every point of the second surface section 42 is illuminatable with laser light of predefinable intensity.

The laser light impinging on the surface sections 41, 42 is converted by the light wavelength conversion element 4 proportionally into light, so-called secondary light, the intensity maximum of which is in the wavelength range of 520 nanometers to 590 nanometers.

The light wavelength conversion element 4 may include or essentially consist of a light-transmissive sapphire lamina coated with phosphor, wherein cerium-doped yttrium aluminum garnet (YAG:Ce) is used as the phosphor. The phosphor is excited by means of the laser light generated by the laser diodes 11 to 16. It converts the laser light, also called primary light, proportionally into secondary light having a longer wavelength, which has an intensity maximum in the wavelength range of 520 nanometers to 590 nanometers. The light wavelength conversion element 4 therefore emits white light which is a mixture of non-converted blue primary light and converted yellow secondary light. The white light emitted by the light wavelength conversion element 4 is projected directly onto the roadway by means of a secondary optical unit 5 of a motor vehicle headlight. In the case of the lighting device in accordance with the first embodiment, the light wavelength conversion element 4 is operated in transmission.

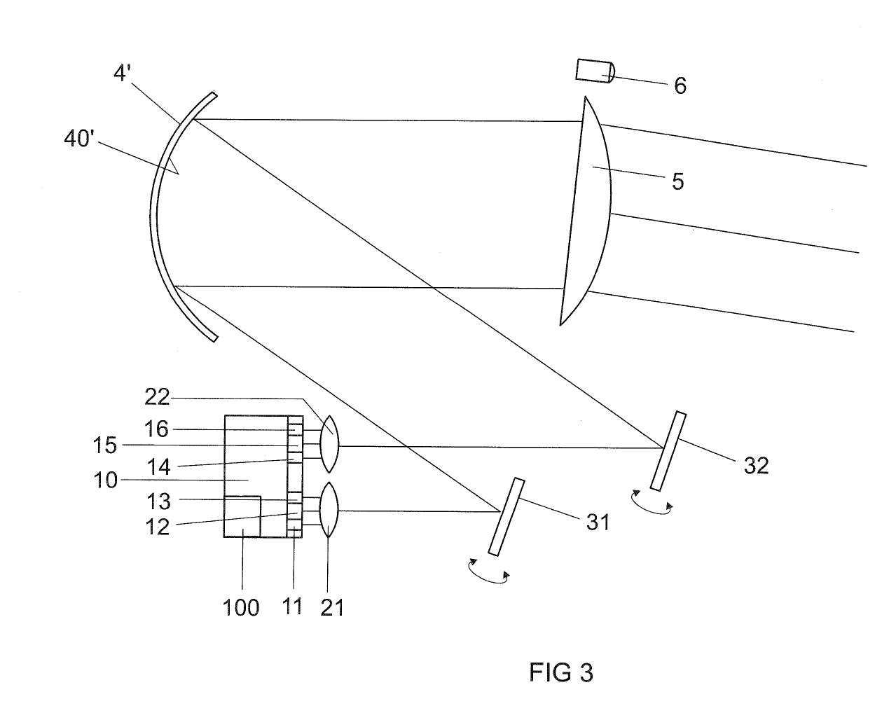

FIG. 3 schematically illustrates a lighting device in accordance with the second embodiment.

The lighting device in accordance with the second embodiment differs from the lighting device in accordance with the first embodiment only in the different embodiment of the light wavelength conversion element 4′. Both lighting devices correspond in all other details. Therefore, the same reference signs are used for identical components in FIG. 1 and FIG. 3 and for the description thereof reference is made to the description of the corresponding component of the lighting device in accordance with the first embodiment, and only details of the light wavelength conversion element 4′ of the lighting device in accordance with the second embodiment are explained more specifically below.

The light wavelength conversion element 4′ may include or essentially consist of a metallic mirror having a concave, for example spherically curved and light-reflecting surface 40′, which is coated with phosphor. Cerium-doped yttrium aluminum garnet (YAG:Ce) serves as the phosphor. The laser light directed onto the surface 40′ of the light wavelength conversion element 4′ by the pivotable mirrors 31, 32 is converted proportionally into secondary light having wavelengths principally from the wavelength range of 520 nanometers to 590 nanometers upon passing through the phosphor. Both the non-converted portion of the blue laser light, also called primary light, and that portion of the laser light which is converted into yellow secondary light are reflected at the surface 40′ of the light wavelength conversion element 4′ and are scattered at the phosphor particles. As a result, the regions of the surface 40′ of the light wavelength conversion element 4′ which are illuminated with laser light emit white light which is a mixture of non-converted blue primary light and converted yellow secondary light. The light wavelength conversion element 4′ of the lighting device in accordance with the second embodiment is operated in reflection. The white light is projected onto the roadway in front of the motor vehicle by means of the secondary optical unit 5.

The light wavelength conversion element 4′ of the lighting device in accordance with the second embodiment may have the effect over the light wavelength conversion element 4 of the lighting device in accordance with the first embodiment that the diameter of the laser spot of the laser light impinging on the spherically embodied surface 40′ is virtually independent of the value of the angle of incidence of the laser light on the mirrors 31, 32, while the diameter of the laser spot of the laser light impinging on the surface 40 embodied in a planar fashion likewise increases with an increasing angle of incidence of the laser light on the mirrors 31, 32.

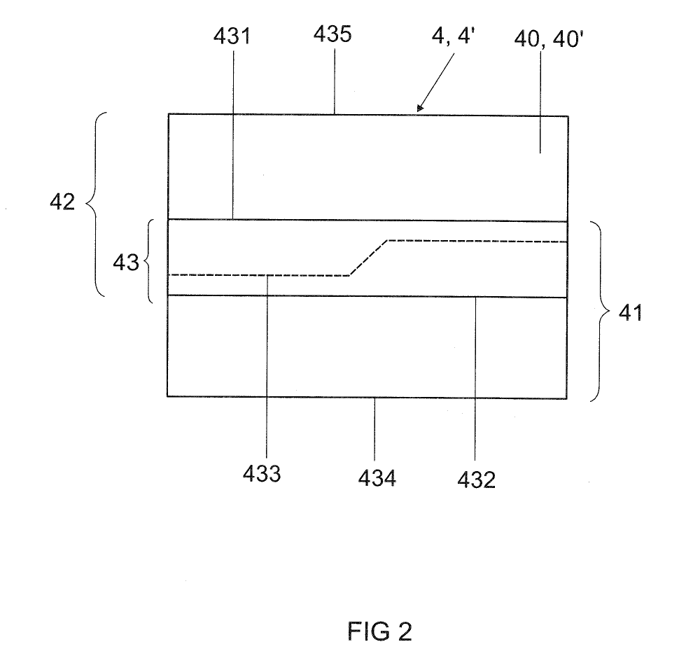

FIG. 2 depicts in schematic illustration a plan view of the surface 40 or 40′ of the light wavelength conversion element 4 or 4′ of the lighting device in accordance with the first or respectively second embodiment, which surface is scanned with laser light by means of the pivotable mirrors 31, 32. The surface 40 or 40′ has a first surface section 41 which is scannable with laser light only with the aid of the first pivotable mirror 31 and laser diodes 11, 12, 13 of the first laser diode group, and a second surface section 42, which is scannable with laser light only with the aid of the second pivotable mirror 32 and the laser diodes 14, 15, 16 of the second laser diode group. In the illustration of FIG. 2, the first surface section 41 is delimited by the fictitious horizontal line 431 and the lower edge 434 and also the side edges of the light wavelength conversion element 4 or 4′. In the illustration in FIG. 2, the second surface section 42 is delimited by the fictitious horizontal line 432 and the upper edge 435 and also the side edges of the light wavelength conversion element 4 or 4′.

The first surface section 41, which is scannable only by the first pivotable mirror 31, and the second surface section 42, which is scannable only by the second pivotable mirror 32, partly overlap, mainly in the region 43 of overlap. That is to say that the surface 40 or 40′ of the light wavelength conversion element 4 or 4′ can be scanned in the region 43 of overlap both with laser light from the first pivotable mirror 31, said laser light being generated by the laser diodes 11, 12, 13 of the first laser diode group, and with laser light from the second pivotable mirror 32, said laser light being generated by the laser diodes 14, 15, 16 of the second laser diode group. In the region 43 of overlap, which is delimited by the two fictitious horizontal lines 431, 432 and the side edges of the light wavelength conversion element 4 or 4′, the surface 40 or 40′ of the light wavelength conversion element 4 or 4′ can therefore be illuminated or scanned with a higher laser light intensity than outside the region 43 of overlap.

As an example of an application, the generation of a light distribution of the low beam with bright-dark boundary 433 by the lighting devices in accordance with the first and second embodiments will be described with reference to the illustration in FIG. 2.

In order to generate the light distribution for the low beam with bright-dark boundary 433, the first surface section 41 of the surface 40 or 40′ of the light wavelength conversion element 4 or 4′ is scanned with laser light line by line and column by column with the aid of the first mirror 31 and the laser diodes 11, 12, 13 of the first laser diode group. The laser diodes 11, 12, 13 of the first laser diode group are switched on during the scanning of the region of the first surface section 41 arranged below the bright-dark boundary 433 by the first mirror 31. During the scanning of the region of the first surface section 41 arranged above the bright-dark boundary 433 by means of the first mirror 31, by contrast, the laser diodes 11, 12, 13 of the first laser diode group are switched off. The laser diodes 11, 12, 13 of the first laser diode group are switched on and off by the controller 100 synchronously with the pivoting movement of the first mirror 31. In addition, for generating the light distribution for the low beam with bright-dark boundary 433, the second surface section 42 of the surface 40 or 40′ of the light wavelength conversion element 4 or 4′ is scanned with laser light line by line and column by column with the aid of the second mirror 32 and the laser diodes 14, 15, 16 of the second laser diode group. The laser diodes 14, 15, 16 of the second laser diode group are switched on during the scanning of the region of the second surface section 42 arranged below the bright-dark boundary 433 by means of the second mirror 32. During the scanning of the region of the second surface section 42 arranged above the bright-dark boundary 433 by means of the second mirror 32, by contrast, the laser diodes 14, 15, 16 of the second laser diode group are switched off. The laser diodes 14, 15, 16 of the second laser diode group are switched on and off by the controller 100 synchronously with the pivoting movement of the second mirror 32.

That region of the region 43 of overlap which lies below the bright-dark boundary 433 is therefore scanned by means of both mirrors 31, 32 with laser light generated by the laser diodes 11 to 16 of both laser diode groups. Said region is therefore scanned with the highest laser light intensity. That region of the first surface section 41 which lies outside the region 43 of overlap is scanned by means of the first mirror 31 only with laser light generated by the laser diodes 11, 12, 13 and is therefore illuminated with the lower laser light intensity. That region of the region 43 of overlap and of the second surface section 42 which lies above the bright-dark boundary 433 is not illuminated with laser light generated by the laser diodes 11 to 16 for the purpose of generating the low-beam light distribution. The regions of the surface 40 or 40′ of the light wavelength conversion element 4 or 4′ which are scanned with laser light convert the laser light, which is light from the spectral range of blue light, proportionally into secondary light, which is light from the spectral range of yellow light. The regions of the surface 40 or 40′ of the light wavelength conversion element 4 or 4′ which are scanned with laser light therefore emit white light which is a mixture of blue primary light and yellow secondary light. The secondary light emitted by the light wavelength conversion element 4 or 4′ has a virtually Lambertian light distribution. The transmitted or reflected primary light that is not converted by the light wavelength conversion element 4 or 4′ is scattered at the phosphor particles of the light wavelength conversion element 4 or 4′. The white light is projected onto the roadway in front of the motor vehicle by the secondary optical unit 5.

During this projection, the bright-dark boundary 433 with the above-described distribution of the light intensity is likewise imaged on the roadway. The region near the bright-dark boundary, despite greater distance from the motor vehicle, therefore appears on the roadway to be just as bright as the region in the near field directly in front of the motor vehicle.

The beam path of the light is shown only highly schematically in the figures. In various embodiments, the Lambertian light distribution of the secondary light and the light scattering of the primary light are not depicted. The secondary optical unit 5 may include optical means, for example a mixing rod, in order to homogenize the mixture of primary light and secondary light and thus the white light emitted by the light wavelength conversion element 4 or 4′.

The lighting devices in accordance with the embodiments described above can in each case additionally be equipped with sensors and a camera 6, in order to measure the intensity of the light projected onto the roadway or a wall or a screen and, in a manner dependent thereon, to calibrate the brightness of the light emitted by the laser light source arrangement 10, such that, for example, the light distribution generated corresponds to the legal provisions, or in order to detect events in traffic and to adapt the lighting thereto.

The invention is not restricted to the embodiments explained in greater detail above. By way of example, a larger or smaller number of laser diodes can be used in order to be able to modulate the brightness of the laser light source arrangement of the lighting device to a greater or lesser extent. Instead of a plurality of laser light sources, light beam splitters can also be employed in order to increase the number of laser light beams for the pivotable mirrors. Moreover, it is also possible to use more than just two pivotable mirrors and to subdivide the laser diodes into correspondingly more groups for illuminating the pivotable mirrors, in order to be able to generate a greater diversity of light distributions. Furthermore, it is also possible to use a plurality of light wavelength conversion elements for the lighting device, in order to be able to realize for example different lighting functions with different light distributions.

Furthermore, individual features or components of the two embodiments explained above can also be combined with one another. By way of example, the light wavelength conversion element 4′ having the curved surface 40′ can also be embodied as light-transmissive and operated in transmission.

Moreover, by way of example, the light wavelength conversion element of the lighting device in accordance with the first embodiment can have a curved surface, the curvature of which is adapted to the primary optical units 21, 22. By using a secondary optical unit 5 adapted to the curvature of the curved surface of the light wavelength conversion element, it is possible to achieve a very good imaging of the light distribution on the light wavelength conversion element into the near field and far field of the motor vehicle headlight. In various embodiments, it is thereby possible to avoid a widening of the laser spot, caused by relatively large angles of incidence of the laser light on the pivotable mirrors or by the imaging of the light wavelength conversion element by means of the secondary optical unit.

Furthermore, the pivotable mirrors (MEMS) in accordance with the embodiments explained above can be designed for a resonant operating mode or alternatively for a non-resonant operating mode. The laser light source arrangement 10 can also be embodied such that laser light sources of a first group of laser light sources emit laser light having a first wavelength and laser light sources of another group of laser light sources emit laser light having a second wavelength, which differs from the first wavelength, in order for example to vary the color of the light emitted by the lighting device.

The pivotable mirrors can moreover also be embodied such that the light wavelength conversion element is not scanned line by line and column by column, rather the laser light is guided over the surface of the light wavelength conversion element by the pivotable mirrors in some other way, for example in the form of Lissajous figures. The pivoting movements of the pivotable mirrors can be carried out synchronously, that is to say at the same frequency, or at different frequencies.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting device, comprising:
a laser light source arrangement;
at least two pivotable mirrors; and
at least one light wavelength conversion element;
wherein the lighting device is embodied in such a way that light generated by the laser light source arrangement is directed onto at least one light wavelength conversion element by the pivotable mirrors;
wherein the at least two pivotable mirrors are embodied in such a way that light reflected at a first pivotable mirror is directable onto a first surface section of at least one light wavelength conversion element in order to form a first illuminatable region of the at least one light wavelength conversion element, and light reflected at a second pivotable mirror is directable onto a second surface section of the at least one light wavelength conversion element in order to form a second illuminatable region of the at least one light wavelength conversion element;
wherein the first and second illuminatable regions partly overlap.

2. The lighting device of claim 1,
wherein the at least two pivotable mirrors are embodied as Micro Electro Mechanical Systems (MEMS mirrors).

3. The lighting device of claim 1,
wherein the at least one laser light source arrangement comprises a plurality of laser diodes.

4. The lighting device of claim 1,
wherein provision is made of a controller for the at least two pivotable mirrors.

5. The lighting device of claim 1,
wherein provision is made of a controller for the laser light source arrangement.

6. The lighting device of claim 1, further comprising:
an optical apparatus configured to shape the laser light beam, wherein the optical apparatus is disposed downstream of the at least one laser light source arrangement.

7. The lighting device of claim 1,
wherein the surface of the at least one light wavelength conversion element is embodied in a curved fashion.

8. The lighting device of claim 1, further comprising:
an optical unit disposed downstream of the at least one light wavelength conversion element.

9. The lighting device of claim 1,
wherein the at least one laser light source arrangement is configured to generate light having wavelengths from the wavelength range of 380 nanometers to 490 nanometers and the at least one light wavelength conversion element is embodied in such a way that it converts light having wavelengths from the wavelength range of 380 nanometers to 490 nanometers proportionally into light having an intensity maximum in the wavelength range of 520 nanometers to 590 nanometers.

10. The lighting device of claim 1,
wherein provision is made of at least one sensor or one camera for controlling the lighting device.
